(19) United States
(12) Patent Application Publication
(10) Pub. No.: US 2013/0327559 A1
(43) Pub. Date: Dec. 12, 2013

(54) POWER CABLE FOR PORTABLE DEVICES

(71) Applicants: Min Chul Kim, Santa Clara, CA (US); Nathan N. Ng, Fremont, CA (US); Josh Pong, San Jose, CA (US)

(72) Inventors: Min Chul Kim, Santa Clara, CA (US); Nathan N. Ng, Fremont, CA (US); Josh Pong, San Jose, CA (US)

(73) Assignee: Apple Inc., Cupertino, CA (US)

(21) Appl. No.: 13/492,724

(22) Filed: Jun. 8, 2012

(51) Int. Cl. H01B 9/04; H01R 43/00

(52) U.S. Cl. 174/113 R; 29/868

(57) ABSTRACT

Power cables having improved strength, a uniform feel, good flexibility, and consistent series resistance. One example may use one or more aramid fibers to strengthen a power cable. These fibers may be flattened such that they have a low profile in the direction of a diameter of the cable. A thickness and number of wires in one or more conductors in the cables may be adjusted to provide a good feel and good flexibility. The wires may also be twisted during the construction to improve flexibility. Another example may control variations in series resistance varying a number of wires in the one or more conductors.

### BACKGROUND

The number and types of electronic devices available to consumers have increased tremendously the past few years, and this increase shows no signs of abating. Devices such as portable computing devices, tablet, desktop, and all-in-one computers, cell, smart, and media phones, storage devices, portable media players, navigation systems, monitors and other devices have become ubiquitous.

These devices often receive power using various power cables. These power cables may have connector inserts, or plugs, on at least one end. The connector inserts may plug into connector receptacles on the electronic devices, thereby forming one or more conductive paths for power and ground.

These cables are handled when users make or break electrical connections, and at other times. At such times, a user may pull on a cable. To avoid damage to the cables, it may be desirable that these power cables have good strength.

Also, a cable that appears to be poorly manufactured can negatively influence a user. Accordingly, it may be desirable that the cable not feel as though it is nonuniform, or appears to have been formed in an uneven or haphazard manner.

Moreover, since these cables are intended for external use (as opposed to being encased in a housing), they are often twisted and bent in various ways by users. These twists and bends may damage conventional cables. For these reasons, it may not only be desirable that these cables be strong, but that they also be flexible.

These cables may include one or more conductors formed of several individual wire strands. These individual wires may vary in thickness due to manufacturing tolerances. This variation in thickness may vary the resistance of conductors in the cables. Accordingly, it may be desirable to account for this variation.

Thus, what is needed are power cables that may have a improved strength, a uniform feel, good flexibility, and consistent series resistance.

### SUMMARY

Accordingly, embodiments of the present invention may provide power cables having improved strength, a uniform feel, good flexibility, and consistent series resistance.

An illustrative embodiment of the present invention may provide a power cable having improved strength. This may be achieved by the use of fibers. An illustrative embodiment of the present invention may use one or more aramid fibers to strengthen a power cable. In a specific embodiment of the present invention, Kevlar™ fibers may be used.

The use of these fibers, without more, may lead to a cable having a nonuniform feel. Specifically, the fibers may appear as lumps that provide an uneven feel to the cable. This feel may provide a user with a poor impression and the user may surmise that the cable has been poorly manufactured. This nonuniformity may inhibit the flexibility of the cable as well.

Accordingly, an illustrative embodiment of the present invention may provide a cable having a uniform feel by flattening these fibers such that they have a low profile in the direction of a diameter of the cable. This low profile may in turn reduce any nonuniform feel that may otherwise arise, and it may improve flexibility as well. One or more other fibers may be located in a center of the cable, where they do not disrupt the uniform feel to the cable.

Another illustrative embodiment of the present invention may provide improved flexibly in other ways as well. For example, a power cable may include one or more conductors formed of a number of individual wires or wire strands. These individual wires may be uninsulated or insulated. The thickness and the number of wires may be adjusted to provide a good feel and good flexibility for the cable. The wires may also be twisted during the construction of the power cable to improve flexibility.

Once a desired thickness of these wires is determined, uncertainties in the manufacturing process may cause variations in the actual thickness of these individual wire strands. Without more, this may lead to variations in thickness of the cable as well as variations in series resistance of the conductor.

Accordingly, an illustrative embodiment of the present invention may compensate for variations in the thickness of the wire strands by changing the number of individual wire strands used. When individual wire stands are thicker, their number may be reduced. This may prevent the cable from becoming thicker while maintaining proper series resistance. Similarly, when individual wire strands are thinner, their number may be increased. This may prevent the series resistance from increasing while again maintaining proper cable thickness.

An illustrative embodiment of the present invention may achieve this by measuring a resistance of a wire that is representative of the individual wires. This may be done by measuring the resistance of a section or length of wire from a spool that the individual wires are pulled from. By knowing this resistance, the desired resistance of the completed conductor, and the relative lengths of the section of wire and the cable, the number of individual wire strands to be used can be determined. To simplify manufacturing, the number of individual wire strands to be used can be read from a look-up table given the resistance of a section or length of wire.

It should be noted that while the above and the included examples discuss power cables, embodiments of the present invention may also be used to improve cables that convey one or more signals, such as power, data, status, bias, or other signal or signals.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates an electronic system that may be improved by the incorporation of embodiments of the present invention;

FIG. 2 illustrates a cross-section of a power cable according to an embodiment of the present invention;

FIG. 3 illustrates a close-up view of a fiber and a second conductor according to an embodiment of the present invention;

FIG. 4 illustrates a spiral twist of a conductor according to an embodiment of the present invention;

FIG. 5 illustrates another power cable according to an embodiment of the present invention; and

FIG. 6 illustrates a method of compensating for changes in thickness of wire strands used in forming conductors for a cable according to an embodiment of the present invention.

### DESCRIPTION OF ILLUSTRATIVE EMBODIMENTS

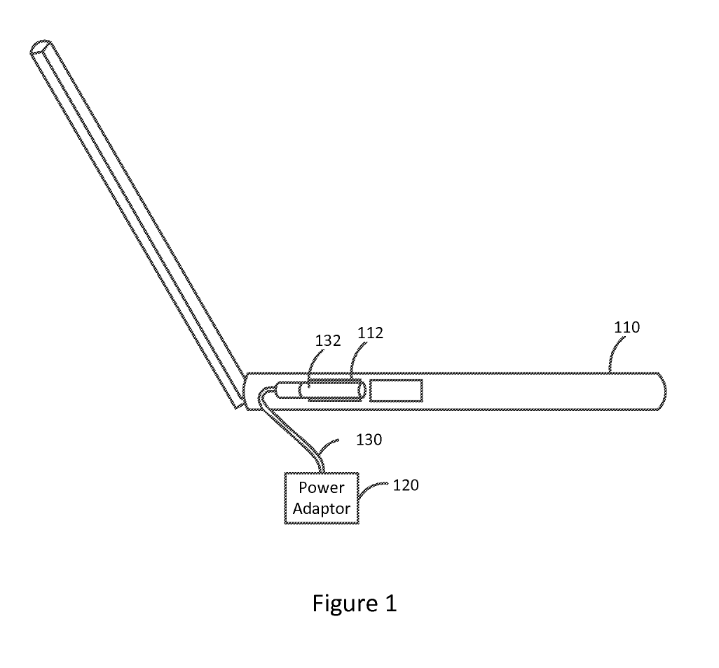

FIG. 1 illustrates an electronic system that may be improved by the incorporation of embodiments of the present invention. This figure, as with the other included figures, is shown for illustrative purposes and does not limit either the possible embodiments of the present invention or the claims.

This figure includes electronic device 110. In this specific example, electronic device 110 may be a laptop computer. In other embodiments of the present invention, electronic device 110 may be a netbook or tablet computer, cell, media, or smart phone, global positioning device, media player, or other such mobile device. In still other embodiments of the present invention, electronic device 110 may be a desktop computer, set-top box, monitor, or other non-mobile device.

Electronic device 110 may include a battery (not shown). The battery may provide power to electronic circuits in electronic device 110. This battery may be charged using power adapter 120. Specifically, power adapter 120 may receive power from an external source, such as a wall outlet or car charger. Power adapter 120 may convert received external power, which may be AC or DC power, to DC power, and it may provide the converted DC power over cable 130 to plug 132. In other embodiments of the present invention, plug, or insert 132 may be coupled through cable 130 to another type of device. Plug 132 may be arranged to mate with receptacle 112 on electronic device 110. Power may be received at receptacle 112 from plug 132 and provided to the battery and electronic circuitry in electronic device 110. In other embodiments of the present invention, data or other types of signals may also, or instead, be provided to electronic device 110 via cable 130.

In embodiments of the present invention where cable 130 provides power, cable 130 may include two conductors. One such conductor may convey power, while the other may convey a ground return. An example is shown in the following figure.

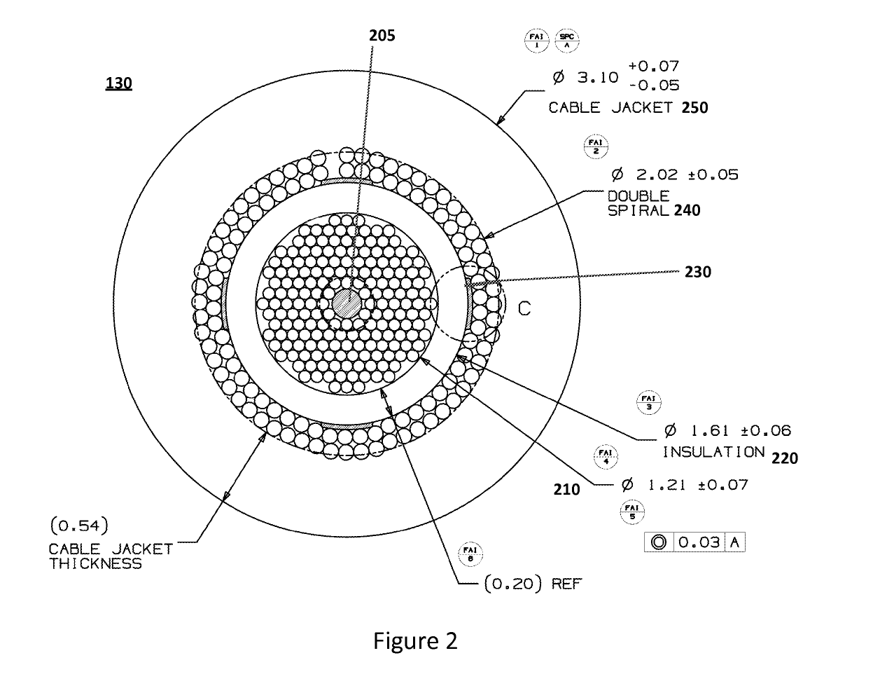

FIG. 2 illustrates a cross-section of a power cable 130 according to an embodiment of the present invention. Cable 130 may include a center conductor 210. Center conductor 210 may be comprised of a number of individual wires or wire strands. These wires may be insulated or non-insulated. These wires may be formed of copper, tinned copper, aluminum, or other conductive material. Center conductor may surround a central fiber 205. Central fiber 205 may be formed of a strengthening material such as aramid, or it may be made using another material.

Center conductor 210 may be encased by insulation layer 220. Insulation layer 220 may be formed of a nonconductive material.

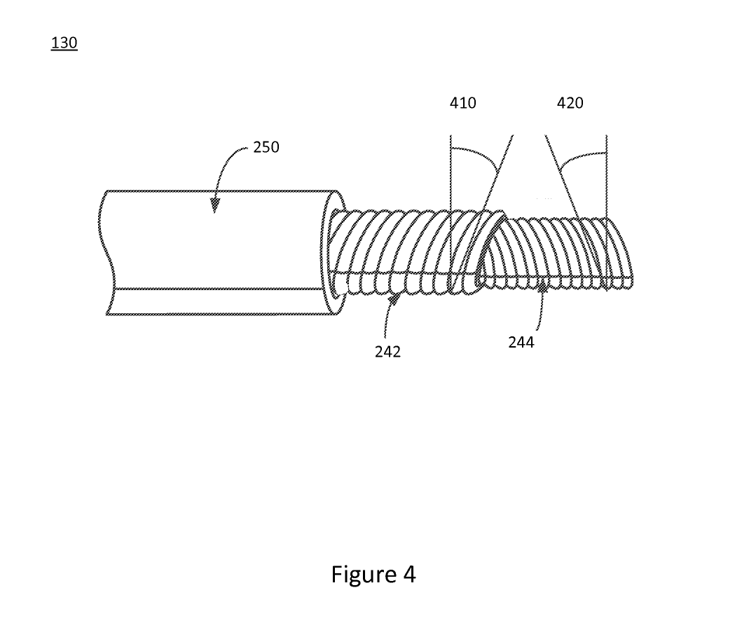

Cable 130 may include a second conductor 240. Second conductor 240 may be comprised of a number of individual wires or wire strands. Second conductor 240 may surround insulation layer 240. These wires may be insulated or non-insulated. These wires may be formed of copper, tinned copper, aluminum, or other conductive material. In this specific example, a second conductor 240 may be formed as a double spiral. Examples of how this may be formed are shown below in FIG. 4.

Second conductor 240 may be encased by second insulating layer or cable jacket 250. Cable jacket 250 may be formed of a nonconductive material.

Again, it may be desirable to improve the strength of these cables. Strengthening the cables may help avoid breakage due to bending, twisting, or disconnects between cable inserts and receptacles. Accordingly, embodiments of the present invention may employ fibers 230. Fibers 230 may be aramid fibers. In a specific embodiment of the present invention, fibers 230 may be formed of Kevlar™. In this specific embodiment of the present invention, four aramid fibers 230 are shown, though in other embodiments of the present invention, other numbers of fibers 230 may be employed. Also, while fibers are shown in this example as being between first insulating layer 220 and second conductor 240, aramid fibers may be placed at other or multiple locations. For example, one or more aramid fibers 230 may be placed between first conductor 210 and first insulating layer 220, between second conductor 240 and jacket 250, or at other single or multiple locations in cable 130.

Again, it may be desirable that aramid fibers 230 not create lumps or nonuniformities in cable 130. Accordingly, embodiments of the present invention may employ flattened aramid fibers 230. These fibers 230 may be flattened such that they have a low profile in the direction of the diameter of cable 130. In this way, aramid fibers 230 do not create an uneven feel for cable 130.

It may also be desirable that cable 130 have a desired feel and flexibility. This feel and flexibility may be adjusted by varying the thickness and number of wires in conductors 210 and 240. For example, if conductor 210 is formed of a single wire, that wire would be relatively stiff, and thus cable 130 would not be particularly flexible. Accordingly, conductors 210 and 240 may be formed using a number of smaller, lower diameter wire strands.

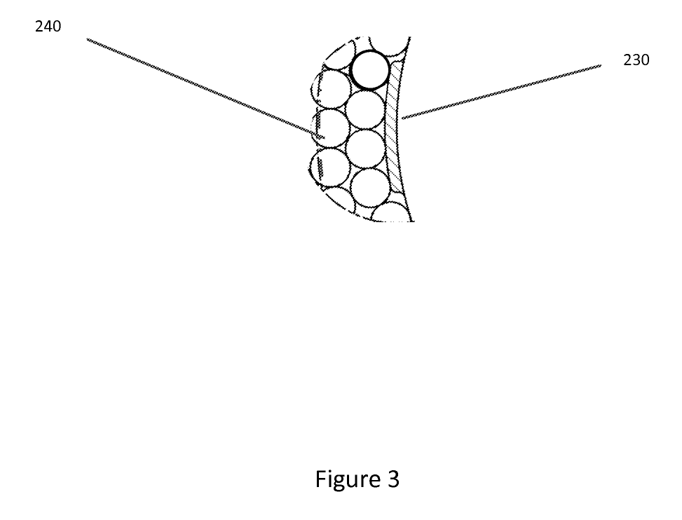

FIG. 3 illustrates a close-up view of aramid fiber 230 and second conductor 240 according to an embodiment of the present invention. Again, aramid fibers 230 may be flattened in a radial direction along a diameter of cable 130. As can be seen, the inclusion of fiber 230 creates only minor deviation in the placement of some of the wire strands of second conductor 240.

To further promote flexibility, either or both of the conductors 210 and 240 may be twisted along the axial length of cable 130. This twisting is done to prevent the excessive compression and expansion that would occur in individual wires of conductors 210 and 240 when cable 130 is bent. An example is shown in the following figure.

FIG. 4 illustrates a spiral twist of a conductor according to an embodiment of the present invention. In this figure, two layers of second conductor 240 are shown as layers 242 and 244 and are formed as a double spiral. In this specific example, each layer is shown as a counter rotating spirals 242 and 244. These counter rotating spirals may have relative angles 410 and 420. In other embodiments of the present invention, both layers 242 and 244 may rotate in a same direction.

This rotation or twist may be applied to the center conductors well. For example, center conductor 210 may be twisted before first insulation layer 220 is applied.

Again, these rotating spirals may help improve the flexibility of cable 130. For example, if the wires of conductor 240 are straight, when cable 130 is bent, some wire strands undergo or receive expansion stress, while other wires are compressed. By twisting the wires as shown, these forces are distributed along the wires, thereby improving flexibility.

Again, in the above examples, two conductors may be used. For example, a center conductor may be used to convey power, while an outer conductor may be used to convey ground. In other embodiments of the present invention, other wires may be included to convey data or other signals. An example is shown in the following figure.

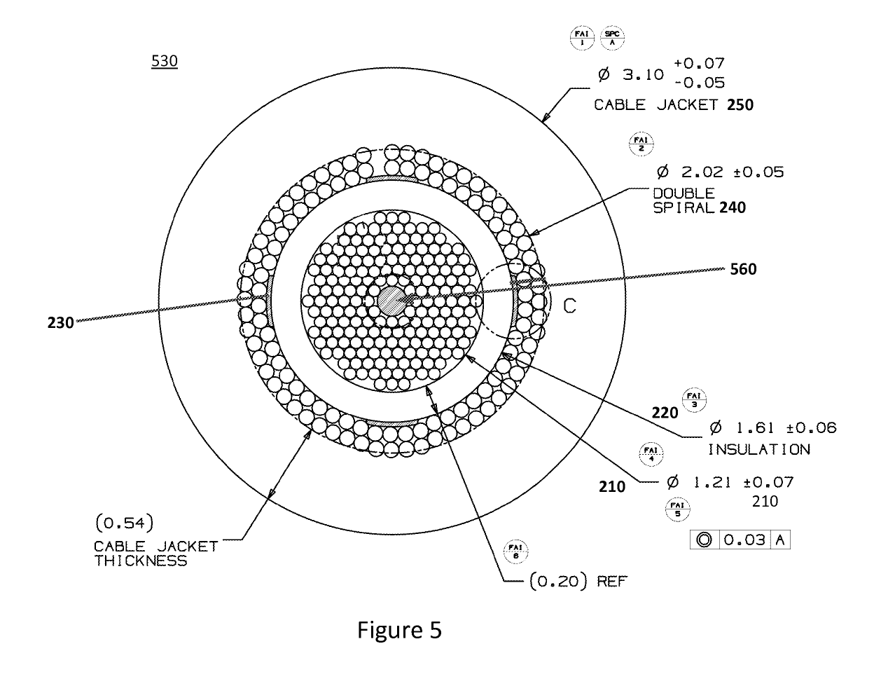

FIG. 5 illustrates a power cable 530 according to an embodiment of the present invention. As before, this cable may include a first or central conductor 210 surrounded by insulation layer 220. A second conductor 240 may surround the first insulation layer 220 and in turn be surrounded by cable jacket 250. Fibers 230, which may be formed of aramid or other material, may also be included. Instead of a central fiber 205 as shown in FIG. 2, or more signal lines 560 may also be included in a center of cable 530. In this specific example, signal line 560 may be located in the center of central or first conductor 210. Signal line 560 may, for example, convey a signal indicating a status of a connection between connector insert 132 and receptacle 112 in FIG. 1. In other embodiments of the present invention, signal line 560 may be used to convey other information. Other signal lines may be included, either in a center of conductor 210 or in other locations in cable 530.

Again, the individual wire strands used in the first connected 210 and the second conductor 240 may have variable diameters, and therefore variable resistances. Without more, this variation may make some finished cables excessively resistive, while other cables may become excessively thick. Accordingly, embodiments of the present invention may compensate for this variation. An example is shown in the following figure.

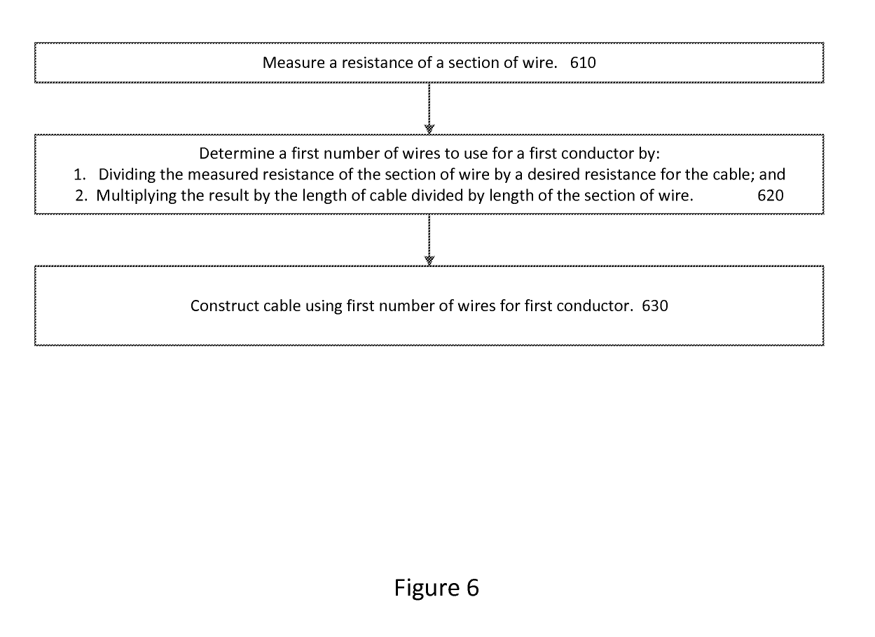

FIG. 6 illustrates a method of compensating for changes in thicknesses of wire strands used in forming conductors for a cable according to an embodiment of the present invention. Again, the diameters of these wire strands may vary due to manufacturing tolerances. If these wire strands are thin, cable resistance may increase. If these wire strands are thick, overall thickness of the cable may increase. Accordingly, embodiments of the present invention may vary the number of wire strands in conductors to compensate for manufacturing causes of individual wire strands.

In act 610, the resistance of a section of a wire strand may be measured. This wire strand may be a wire strand that is actually going to be used in the manufacturing of a cable, it may be a wire strand from a spool from which wire strands for the cable may be pulled, or it may otherwise be representative of wire strands that may be used in the cable.

In act 620, a first number of wires to be used for a first conductor is determined. This determination may be made by dividing the measured resistance of the section of wire by a desired resistance for the cable. To compensate for the fact that the section of wire measured may not be the same length as the cable, the result may be multiplied by the length of the cable divided by the length of the section of wire. The cable may then be constructed using a first number of wires in act 630.

It should be noted that while an equation is used in this example to calculate a number of conductors, in other embodiments of the present invention, to simplify production, a look-up table may be used. Specifically, a resistance of a section of wire may be measured in act 610. This may be input to a lookup table based on the calculations in act 620. The output of the lookup table may then be used to provide a first number of wires to be used for the first conductor.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A power cable comprising:
a center conductor comprising a first plurality of wires;
a first insulating layer surrounding the center conductor;
an outer conductor comprising a second plurality of wires;
a plurality of fibers between the first insulating layer and the outer conductor; and
a second insulating layer surrounding the outer conductor.

2. The power cable of claim 1 wherein at least one of the plurality of fibers is flattened, and a flattened surface of the at least one of the plurality of fibers is located against the first insulating layer.

3. The power cable of claim 2 wherein at least one of the plurality of fibers is an aramid fiber.

4. The power cable of claim 3 wherein the wires in the first plurality of wires are each an uninsulated wire.

5. The power cable of claim 4 wherein the center conductor is a power conductor.

6. The power cable of claim 3 wherein the wires in the second plurality of wires are each an uninsulated wire.

7. The power cable of claim 6 wherein the outer conductor is a ground conductor.

8. A method of constructing a power cable, the method comprising:
forming a center conductor using a first number of wires;
covering the center conductor with a first insulating layer;
flattening a first number of fibers;
placing a first flattened surface of each of the first number of fibers on the first insulating layer;
forming an outer conductor using a second number of wires located on the first insulating layer such that the first number of fibers are between the outer conductor and the first insulating layer; and
covering the outer conductor with a second insulating layer.

9. The method of claim 8 wherein the first number of wires is determined by measuring a resistance of at least a section of one wire representative of the first number of wires.

10. The method of claim 9 wherein the first number of wires is further determined by using a desired resistance for the center conductor and the measured resistance to determine the first number of wires.

11. The method of claim 8 wherein the center conductor is formed by unspooling the first number of wires and twisting the first number of wires.

12. The method of claim 8 wherein the second number of wires is determined by measuring a resistance of at least a section of one wire representative of the second number of wires.

13. The method of claim 12 wherein the second number of wires is further determined by using a desired resistance for the outer conductor and the measured resistance to determine the second number of wires.

14. A power cable comprising:
a first conductor;
a second conductor insulated from the first conductor;
a plurality of fibers, wherein the fibers have been substantially flattened.

15. The power cable of claim 14 wherein the second conductor surrounds the first conductor.

16. The power cable of claim 14 wherein at least one of the plurality of fibers comprises an aramid fiber.

17. A method of constructing a power cable comprising:
forming a first conductor comprising a first number of wires by:
measuring a resistance of a section of a wire representative of the first number of wires; and
using a desired resistance for the first conductor and the measured resistance to determine the first number of wires.

18. The method of claim 17 further comprising:
forming a second conductor comprising a second number of wires by:
measuring a resistance of a section of a wire representative of the second number of wires; and
using a desired resistance for the second conductor and the measured resistance to determine the second number of wires.

19. The method of claim 17 further comprising flattening a first plurality of fibers and constructing the power cable using the first plurality of fibers.

20. The method of claim 19 wherein at least one of the first plurality of fibers comprises an aramid fiber.
